(19) United States
(12) Patent Application Publication
(10) Pub. No.: US 2007/0241692 A1
(43) Pub. Date: Oct. 18, 2007

(54) Driving arrangement for a passive matrix self-emitting display element

(75) Inventors: Douwe Thomas De Jong, Heerlen (NL); Markus Heinrich Klein, Heerlen (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/527,892

(22) PCT Filed: Aug. 8, 2003
(86) PCT No.: PCT/IB03/03533

§ 371 Date: Mar. 15, 2005

(30) Foreign Application Priority Data
Sep. 18, 2002 (EP) 02078863.4

(51) Int. Cl. H05B 37/02; G05F 1/00

(52) U.S. Cl. 315/291

(57) ABSTRACT

This invention relates to a driving arrangement for voltage driving of a passive matrix self-emitting display element (1), the driving arrangement comprising: voltage application circuitry (3) for applying a voltage across said self-emitting display element (1), switching devices (4) for switching said voltage between an on and an off state, a charge monitoring unit (5) for monitoring a total charge delivered to said self-emitting display element (1) due to said voltage application circuitry (3) during a drive cycle, and feedback circuitry (9) being arranged to switch said switching devices (4) to the off state, when a predetermined total charge has been delivered to said self-emitting display element (1) by said voltage application circuitry (3) during the drive cycle. The invention also relates to a method of driving such a display element (1), as well as a passive matrix self-emitting display device, comprising a plurality of such light emitting elements (1).

This invention relates to a driving arrangement for voltage driving of a passive matrix self-emitting display element. The invention also relates to a method for driving such a display element, as well as a passive matrix self-emitting display device, comprising a plurality of such light emitting elements.

In more and more display applications, light emitting matrix displays, such as organic light emitting displays (small molecule or polymer-based) or inorganic light emitting displays, are used as thin and flexible alternatives to for example liquid crystal displays. The basic device structure of a light emitting matrix display essentially comprises a structured electrode or anode, a counter electrode or cathode and a light emitting layer being sandwiched between the anode and the cathode. In a passive matrix display the anode may comprise a set of separate parallel anode strips, also referred to as anode columns (or anode rows depending on their direction), each being connected to a current or voltage source. Further, the cathode may in this case also comprise a set of separate parallel cathode strips, also referred to as cathode rows (or cathode columns depending on their direction), their direction being essentially perpendicular to the anode strips or columns. The crossing point of such an anode and cathode essentially defines a pixel or light emitting element of said display device, and said pattern of anodes and cathodes hence define a matrix of pixels.

The light emitting pixel will essentially generate light when a forward current is drawn through the light emitting layer, the current being applied by said anode/cathode pattern. The light originates from electron/hole pairs recombining in the active area with the excess energy partly being emitted as photons, i.e. light. The number of photons generated (i.e. the brightness of the display) depends on the number of electrons/holes injected in the active area, that is, the current flowing through the device. The efficacy (brightness per current) only slightly depends on the current itself.

In terms of voltage, the behaviour looks very different. Diodes usually show a strong current-voltage dependence in the forward direction (exponential or quadratic dependence on the boundary conditions). Around and above the onset voltage, the current dramatically increases with voltage. From the above it can be concluded that the brightness is much more dependent on the applied voltage than on the applied current.

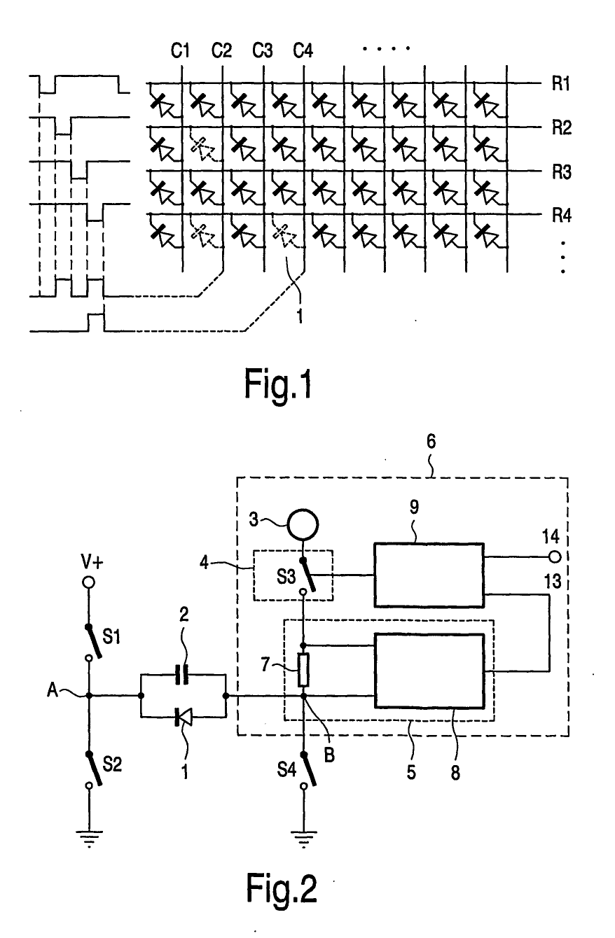

Based on the above, there are essentially two ways of driving a passively driven light emitting matrix display, (the basic overall schematic drawing of such a passively driven matrix display is disclosed in FIG. 1), namely voltage driving and current driving, which in their basic forms are well-known to a man skilled in the art. In the respective cases, a voltage source or a current source is applied to the pixel, thereby causing a current to flow through the light-emitting material.

The main advantages of voltage driving are that no additional voltage, such as a compliance voltage (resulting in additional loss), is necessary to design the voltage driving source and that parasitic display capacitances can be charged up quite rapidly without additional measures. However, in accordance with the above, the brightness level becomes very sensitive to voltage changes and therefore a well controlled voltage source has to be designed. Moreover, any serial resistance will reduce the voltage across the light emitting element. As this resistance is dependent on the pixel location on the display and the display content, crosstalk and artefacts might significantly disturb the quality of a displayed picture.

As regards current driving, the main advantage is the good grey scale control, resulting in fewer display artefacts. However, since a compliance voltage is necessary for most current source designs, this results in an additional loss in the display driver (typically some 20%). Moreover, since the charge-up of the display capacitances should be done as fast as possible, an additional boost source is needed in the case of current driving. Moreover, controlled current sources require a lot of silicon area and are therefore costly to produce. Moreover, in the case of both current and voltage driving, the current/voltage source must by modulated, either by means of amplitude or pulse width, in order to achieve desired grey-scale values. Such modulated sources are however somewhat costly to generate.

Hence, an improved driving arrangement for a passive matrix self-emitting display element is desired.

Hence, an object of the present invention is to provide a passive matrix self-emitting display element to overcome at least some of the problems described above. The invention is defined by the independent claims. The dependent claims define advantageous embodiments.

This and other objects are achieved by a driving arrangement (6) for voltage driving of a passive matrix self-emitting display element; said driving arrangement comprising:

voltage application means, for applying a voltage across said self-emitting display element,

switching means for switching said voltage between an on and an off state,

a charge monitoring unit, for monitoring a total charge delivered to said self-emitting display element by said voltage application means during a drive cycle, and

feedback means being arranged to switch said switching means to the off state, when a predetermined total charge has been delivered to said self-emitting display element by said voltage application means during the drive cycle. This arrangement has the advantages that a voltage source with less strict requirements concerning the accuracy may be used, since only the total charge delivered needs to be considered. As a compliance voltage, which is needed when a current source is used, can be dispensed with the total module power consumption will be significantly reduced. This lowers the cost of the display, as smaller drivers (no modulation of amplitude or pulse width is necessary) may be used, and less of a development effort is needed to implement this source. Furthermore, an excellent brightness control is achieved, resulting in low crosstalk, good display uniformity and fewer artefacts. Moreover, as a voltage source is used, charging of any capacitance can be done rather quickly, and no additional measures (such as an extra current pulse, when current driving is applied) is needed in this aspect.

In accordance with a preferred embodiment of this invention, said charge monitoring unit comprises a current sensor, for sensing the current fed through the display element, being a comparatively straight-forward means of measuring charge. Suitably, said current sensor comprises a resistance or a current follower. The resistance preferably has a value which is an order of magnitude smaller than the pixel resistance in the operating point. Suitably, said charge monitoring unit further comprises an integration device, for integrating a measured current signal from said current sensor, to obtain the monitored total charge delivered to said self-emitting display element. This has the advantage that, since brightness control is done via an integrated quantity, the system is insensitive to any disturbance.

Said integration device suitably comprises an operational amplifier.

Sensing the current as well as integration may also be performed by a capacitor that is connected in series with the self-emitting display element, with the voltage across said capacitor being directly proportional to the integrated current, i.e. the total charge.

Moreover, said feedback means preferably comprises a comparator, being arranged to compare the monitored total charge with the predetermined total charge, and sending a switch-off signal to said switching means as soon as the monitored total charge equals said predetermined total charge. This is a simple way of enabling the desired switch-off function. Preferably, said comparator comprises an operational amplifier.

The self-emitting display element is suitably a polymer, organic or inorganic light emitting element.

The above and other objects are also achieved by a method of driving a passive matrix self-emitting display element comprising the following steps: applying a driving voltage across said display element;

monitoring the total charge delivered to said display element while said driving voltage is having applied; and

interupting the application of the driving voltage when a predetermined charge has been delivered to said display element. In the same way as described above, this method provides the possibility of using a voltage source with lower requirements concerning accuracy, since only the total charge delivered to the light emitting element is of great importance.

Finally, the above and other objects are achieved by a passive matrix self-emitting display device comprising a plurality of light emitting elements arranged in a plurality of lines, the display being arranged so as to be scanned line by line, each of the light emitting elements in a column perpendicular to the lines being arranged so as to be driven by a driving arrangement, as described in claim 1, and, during scanning, all light emitting elements in a line being arranged so as to be connected to a common voltage application means, supplying a common voltage to all of said elements in that line. This enables a simple construction of the display device, and in the same way as described above, the display device may be applied using a voltage source complying with comparatively low requirements regarding accuracy.

The invention will hereinafter be described in further detail, by means of presently preferred embodiments thereof, with reference to the accompanying drawings, in which

FIG. 1 discloses a schematic diagram of a passively driven light emitting diode display, being addressed line by line in a common cathode concept;

FIG. 2 discloses a schematic diagram of a voltage driving arrangement for a pixel, with charge control in accordance with the invention; and

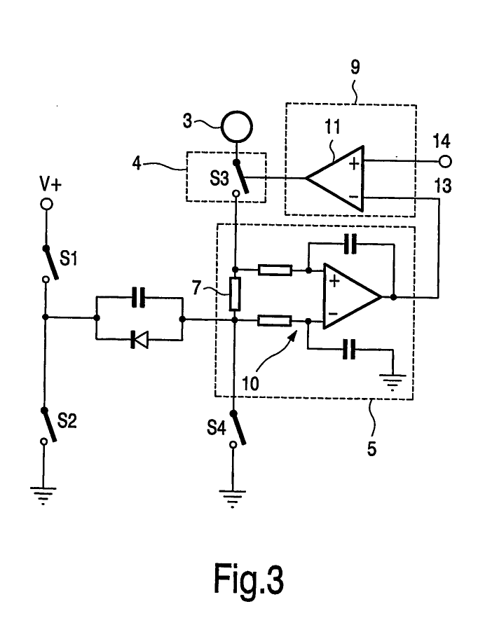

FIG. 3 discloses a schematic diagram of a voltage driving arrangement for a pixel, with charge control in accordance with an embodiment of this invention.

FIG. 1 shows a matrix of rows R1, R2, . . . and columns C1, C2, . . . of light emitting diode elements 1.

As shown on the left-hand side of the matrix, the rows R1, R2, . . . receive sequentially a pulse shaped row voltage. If a light emitting element 1 receives a positive column voltage, via its connection to a column C1, C2 . . . , while its row voltage is low, then a current flows through the element 1 and the element 1 emits light. Based on the waveforms as shown in the example of FIG. 1, the elements shown with dotted lines emit light.

A main embodiment of this invention will hereinafter be described, and is schematically shown in FIG. 2. FIG. 2 discloses the driving arrangement of a single light emitting diode element 1. The capacitor 2, connected in parallel with said light emitting diode element 1 represents the parasitic capacitances present between nodes A and B. The light emitting diode element 1 and the capacitor 2 are connected between a first connection point A, being connected with a first line, such as an anode, and a second connection point B, being connected with a second line, such as a cathode. Said first line is at one end connected with a supply voltage V⁺ via a first switch S1, and at the other end to ground via second switch S2. Via the first switch S1 and the second switch S2 the voltage on the first connection point A can be controlled.

In a similar way, said second connection point B is at one end connected with a voltage source 3 via a driving arrangement, and at the other end to ground via a fourth switch S4. The invention relates to such a driving arrangement. Basically, the driving arrangement comprises switching means 4 and a charge monitoring unit 5, arranged in series between the second connection point B and the voltage source 3. The switching means 4 are arranged to be switched between an ON-state and an OFF-state. In the embodiment shown in FIG. 2, the switching means 4 are constituted by a third switch S3. The charge monitoring unit 5 essentially comprises a current sensor 7, being arranged between third switch S3 and second connection point B, and an integration device 8, being connected in parallel with said current sensor 7. The current detected by said current sensor 7 is a measure of the charge delivered to said light emitting diode element 1 by said voltage source 3; and by integrating this measure over time, by means of said integration device 8, a measure of the total charge delivered to said light emitting diode element 1 is obtained. This measure is the output of the integration device 8.

The driving arrangement further comprises a comparator 9 comprising an integrator value input 13, being connected with an output of the integration device 8, and a grey value input 14, receiving information regarding a desired grey-scale value (i.e. a value representing a desired total delivered charge required for a certain brightness or grey-scale value) of said light emitting element 1 from an image generator circuit (not shown). The comparator 9 is arranged to continuously compare the output of said integration device 8 with the desired grey-scale value for the pixel. Furthermore, the comparator 9 is arranged to control the switching means 4 for switching between said ON-state and said OFF-state, based on the value of said grey-scale value input 14 as compared with the value of the integrated total charge, and is arranged to switch off the switching means when the output from the integration device equals the desired value, thereby disconnecting the voltage source 3.

The function of the above driving arrangement is as follows. At the beginning of a line-scanning operation, and preferably after charging of the display capacitance, the switching means 4 is set to an ON-state, and hence the voltage source 11 causes a current (charge) to be delivered to said light emitting diode element 1 via the current sensor 7 of said charge monitoring unit 5. The total charge delivered to the light emitting diode element is obtained by means of said integration device 8, and the total delivered charge information is continuously delivered to said comparator 9. In the comparator 9, the total delivered charge information is compared with a desired grey-scale value, i.e. a value representing a desired total delivered charge required for a certain brightness or grey-scale value for that pixel or light emitting element. Hence, as soon as the measured total delivered charge equals the desired value, the comparator 9 is arranged to send a switching signal to the switching means 4, whereby the switch is turned to the OFF-state, and the delivery of charge to said light emitting diode element 1 is interrupted. At the beginning of a next line scan, the switching element is again set to the ON-state, the integrator 8 is reset, a new grey scale value input 14 corresponding to the required brightness of a pixel on the next line is supplied, and the above process is repeated.

In the above principal embodiment of the invention, the charge monitoring unit 5 comprises a current sensor 7, which may be constituted by a simple resistor having a small resistance in comparison with the light emitting diode element 1. Alternatively, the current sensor 7 may be embodied so as to be as a current follower, or another suitable means. The integration device 8 may comprise, for example, an operational amplifier arrangement 10, essentially being connected via said current sensor 7, see FIG. 3. Sensing the current as well as integration may also be performed by a capacitor, connected in series with the self-emitting display element, with the voltage across said capacitor being directly proportional to the integrated current, i.e. the total charge. A second operational amplifier 11 may further constitute said comparator. The use of standard operational amplifiers for both the integration device and the comparator results in a construction that is easy and cost-efficient to manufacture.

As stated above, the drawings disclosed in FIGS. 2 and 3 show the driving arrangement of a single light emitting diode element 1 only. However, it shall be noted that, for generating a display, several of such light emitting elements 1 are placed in a matrix, as is disclosed in FIG. 1. Each column of said light emitting elements (1) is connected with a driving arrangement in accordance with this invention. However, the voltage source 3 may preferably be a common voltage source for all light emitting elements in a line (row) of the display. Thereby, a common voltage may be easily applied to all pixels during a line scan (the display is scanned line by line), while the grey-scale value or brightness of the individual light emitting element is regulated by the grey-scale input 13 to each driving arrangement.

Finally, the basic concept behind this invention is that for a light emitting diode device, the emitted light more or less depends on the current through the light emitting material. As a particular ‘amount’ of light has to be produced per frame (the grey value), this translates to a necessary total charge transported through the light emitting element/pixel. If this total charge is monitored (per pixel), a brightness control of the respective pixels is feasible, while the elements emit light. This means that any voltage source may be used as long as one on guarantee that the energy supply is switched off at exactly the time when enough charge/light has been transported/generated. These requirements are much lower than the requirements presently imposed on voltage driven displays in which the exact voltage value is of great importance. Hence, with the arrangement according to the invention, a more cost-efficient voltage source may be used.

The charge control also has to take into account any display capacitance to be charged up. This simply translates to an offset of charge added to the respective grey scale information. Another alternative is to first charge the display capacitance, and thereafter start the charge control.

Hence, this invention enables a driving arrangement to be achieved for a passive matrix self-emitting display, based on light emitting technology (e.g. polymer light emitting diodes), which combines the advantages of voltage and current driving, such as low power, good brightness control, low crosstalk, and low effort. Consequently, the simplicity and efficiency of a passively driven light emitting diode display may be increased considerably by using the invention and scanning such a display line by line.

It shall also be noted that the present invention may be used in a plurality of display arrangements, such as passively driven polymer light emitting displays, organic light emitting displays or inorganic light emitting displays.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A driving arrangement for voltage driving of a passive matrix self-emitting display element (1); said driving arrangement comprising:
voltage application means (3) for applying a voltage across said self-emitting display element (1),
switching means (4) for switching said voltage between an on and an off state,
a charge monitoring unit (5) for monitoring a total charge delivered to said self-emitting display element (1) by said voltage application means (3) during a drive cycle, and
feedback means (9) being arranged to switch said switching means (4) to the off state, when a predetermined total charge has been delivered to said self-emitting display element (1) by said voltage application means (3) during the drive cycle.

2. A driving arrangement (6) according to claim 1, wherein said charge monitoring unit (5) comprises a current sensor (7) for sensing the current fed through the display element (1).

3. A driving arrangement (6) according to claim 2, wherein said current sensor (7) comprises a resistance or a current follower.

4. A driving arrangement (6) according to claim 2, wherein said charge monitoring unit (5) further comprises an integration device (8), for integrating a measured current signal from said current sensor (7), to obtain the monitored total charge delivered to said self-emitting display element (1).

5. A driving arrangement (6) according to claim 4, wherein said integration device (8) comprises an operational amplifier (10).

6. A driving arrangement (6) according to claim 1, wherein said feedback means (9) comprises a comparator (11), being arranged to compare the monitored total charge with the predetermined total charge and to send a switch-off signal to said switching means (4) as soon as the monitored total charge equals said predetermined total charge.

7. A driving arrangement (6) according to claim 6, wherein said comparator (11) comprises an operational amplifier (11).

8. A driving arrangement (6) according to claim 1, wherein said self-emitting display element (1) is one of a polymer, organic or inorganic light emitting element.

9. A method of driving a passive matrix self-emitting display element (1), comprising the following steps:
applying a driving voltage across said display element (1);
monitoring the total charge delivered to said display element (1) while said driving voltage is being applied; and
interupting the application of the driving voltage when a predetermined charge has been delivered to said display element (1).

10. A passive matrix self-emitting display device, comprising a plurality of light emitting elements (1) arranged in a plurality of lines, the display being arranged to be scanned line by line, each of the light emitting elements in a column perpendicular to the lines being arranged to be driven by a driving arrangement (6), as described in claim 1, and, during scanning, all light emitting elements in a line being arranged to be connected to a common voltage application means (3), supplying a common voltage to all of said elements in that line.
